(19) United States
(12) Patent Application Publication
(10) Pub. No.: US 2016/0196766 A1
(43) Pub. Date: Jul. 7, 2016

(54) WEIGHT MANAGEMENT METHOD

(71) Applicant: Chistopher Brian Lundin, Wilmington, DE (US)

(72) Inventor: Christopher Brian LUNDIN, Wilmington, DE (US)

(21) Appl. No.: 15/040,623

(22) Filed: Feb. 10, 2016

Related U.S. Application Data
(63) Continuation-in-part of application No. 14/177,486, filed on Feb. 11, 2014, now abandoned.

(30) Foreign Application Priority Data
Feb. 20, 2013 (ZA) 2013/01293
Feb. 10, 2015 (ZA) 2015/00925

(51) Int. Cl. G09B 19/00; G09B 5/02

(52) U.S. Cl. CPC G09B 19/0092; G09B 5/02

(57) ABSTRACT

This invention is directed to a weight management method, designed to stabilize and optimize insulin levels.

### BACKGROUND OF THE INVENTION

This invention relates to the management of an individual's weight.

A substantial industry exists worldwide in respect of weight management programs typically directed to achieving weight loss. An abundance of high caloric-value foods, particularly in developed countries, and an increase in sedentary occupations and activities, have led to an almost continuous increase in the average weight of dieters. In many countries a majority of the population is overweight and large numbers of people are obese. As a consequence the weight loss industry is substantial and it is estimated that, in the US alone, over sixty billion dollars a year is spent on diets and diet products.

Many techniques have been proposed to achieve weight loss. Without being exhaustive these techniques include the following:

### Counting Calories

A calorie-controlled diet restricts calorie intake by a dieter on a daily basis. The calorie number assigned to a food does not consider the fiber content of the food, the nutritional and vitamin value thereof, the energy needed to digest the food, the satiety effect of the food, the processed food percentage or the amount of additives or preservatives in the food.

Due to the large variety of foods, each with their own calorie content, counting calories may be complex and time-consuming. This is a major contributing factor to the failure of this method of dieting.

Calorie counting and diets based on a point system (see below) often encourage a dieter to drop certain food groups like fat and carbohydrates that are traditionally relatively high in calories or marketed by processed food companies as food to be avoided or replaced with low fat/low calorie processed imitations. Dieters are also rewarded for eating a single food group like, for example, fruit.

Generally, most caloric restrictive diets recommend a fixed calorie intake for a dieter with little or no consideration of the dieter's base metabolic rate (BMR), daily maintenance food requirements or exercise activity.

### Point Systems

Some organisations promote the use of points, as opposed to calories, to simplify diet regimes for an individual. A point system is, in general, based on the calorie levels of foods and, from this point of view, is a modified calorie counting system. A dieter is able to “accumulate” points, a factor which can promote binge eating which is neither healthy nor effective.

Calorie counts are normally done in hundreds. A very low caloric intake is 600. This, in itself, is dangerous. A very high intake is of the order of 3000 which is excessive. In a typical weight loss program a calorie count is set at between 800 to 1200 calories.

To lose weight by counting calories one would either follow a fixed meal plan in which the calories have been already worked out at, say, 800. With 100% compliance a dieter would consume 800 calories. Alternatively a dieter could follow established guidelines to determine his or her estimated base metabolic rate (BMR) before activity and use that as a base line to maintain weight. A reduction in intake creates a caloric deficit.

It is submitted that each approach is flawed and not accurate. No account is taken of a person's muscle mass versus fat mass, nor of the effect of activity which can result in a calorie intake which is not sufficient to sustain health and avoid muscle loss. Most calorie-restricted diets also restrict or minimise certain food groups like carbohydrates or fats, or allow people to accumulate calories for indulging, an occurrence which raises glucose and insulin levels, thereby slowing or shutting down the metabolism process. For example, a serving of 3 ounces of boneless/skinless chicken would be approximately 150 calories and 2 cups of popcorn would be approximately the same number of calories, but would create significantly more glucose and fat storage than the chicken.

In a typical point system used by a leading weight loss company a daily range of approximately 20 to 30 points is established. For example a person would be given a daily number of points of 20 with a weekly bonus of 49 points (7 per day). It is believed that this approach is flawed for a number of reasons:

(1) the point system allows “hoarding” of points. When the accumulated points are used this is often part of a “binge” process and, as indicated, this creates low and high blood sugar levels which affect the metabolic rate and lead to hunger and food cravings;
(2) a target range of, say, 20 to 30 points per day is small. One point variation in the range is equivalent to an approximate 5% variation in the range. No account is taken of the glucose and energy contents of the foods. For example a bagel, granola bar and 3 oz. of boneless/skinless chicken are each equated to 3 points. However the bagel and granola bar respectively create significantly more glucose and fat storage than the chicken;
(3) a point system is not necessarily linked to healthy eating. 6 oz. of skinless chicken and one cup of rice equate to 10 points whereas a meal replacement bar or shake is 3 points. A hamburger is only 6 points;
(4) vegetables are rated at zero points and most fruits are also rated at zero points. This induces a participant in a weight loss program to avoid eating proteins, carbohydrates and fats, and promotes the consumption of meals which do not include protein. These choices manifest themselves in a slow-down of the metabolic rate, fat storage and consumption of muscle for energy; and
(5) a point system generally slows down the metabolic rate due to excessive muscle loss during the weight loss process. It does not necessarily promote an enduring lifestyle change in eating habits. A participant who reverts to a regular diet inevitably gains weight rapidly, due to the reduced muscle mass and to the body being accustomed to survive on fewer calories.

A comprehensive index, usually embodied in a booklet, detailing a multitude of foods and their allocated values, is required to plan a meal, making this diet method difficult to implement and to maintain.

### Glycemic Index

The glycemic index (GI) was developed to determine which foods are best for diabetics. This approach transformed into the marketing of weight loss diets for the public in general. The GI is designed to measure the effect of carbohydrates on blood sugar levels. Without being exhaustive, criticisms which have been levelled at the glycemic index approach include the following:

(a) no account is taken of fat or fiber content in foods, or of a fruit which is consumed with a second food and which could affect the GI of the second food;
(b) the GI of a particular food is measured relative to white bread and no account is taken of exercise;
(c) the GI of a food can vary depending on how the food is cooked or processed; and
(d) depending on blood glucose levels, health factors, insulin-resistance, meals consumed, time of day and the like, the glycemic response to particular foods can be different from one person to another.

### Glycemic Load

The glycemic load is, perhaps, a more accurate indicator of carbohydrate conversion and its effect on blood sugar and insulin levels. Glycemic load considerations are generally more acceptable for use by diabetics and are not particularly useful for individuals who are not diabetic but who are attempting to lose weight. Also, the tracking of a glycemic load index intake can be difficult for the magnitude of a glycemic load is generally based on weight measured in grams.

### Insulin Index

The insulin index is a measure used to quantify the insulin response of an individual to various foods. It is based upon blood insulin levels and not on glucose levels. The index is relative to white bread. However, only a limited amount of research has been done in respect of the insulin index. Taken at face value the use of the insulin index can adversely categorize certain foods such as eggs and meat despite the fact that these types of foods are needed for proper body function in that they produce insulin and cause the body to release glucagon, a composition which keeps blood sugar stable.

### Thermogenesis-Based Diet

This type of diet is primarily focused on high protein foods and limits the intake of fats and carbohydrates. Effectively a person who eats healthy meals from all four food groups is penalized.

The present invention is concerned with a weight management method which aims to address certain shortcomings which are associated with the aforementioned dieting methods by assisting a dieter to eat balanced meals which will maximize fat loss, minimize muscle loss, reduce hunger and cravings and provide balanced nutrition.

The present invention further provides a simplified method to calculate a real nutritional energy value for specific food, a base energy requirement and an acceptable deficit between a dieter's energy requirements and energy consumed.

### SUMMARY OF THE INVENTION

The weight management method of the invention is designed to stabilise and optimise insulin levels which are important in reducing the amount of glucose which is converted to fat. The management of insulin levels can address, at least to some extent, diabetes risk factors. Many overweight people have a condition called “insulin resistance” (IR) which causes an over-production of under-performing insulin which makes it easier to gain weight and harder to lose weight. IR is a primary cause of a slow metabolism.

The method of the invention includes the following steps:

(1) establishing a food index which includes four main categories of food, namely vegetables, proteins, carbohydrates (including starches and fruit), and fat, defining a portion for each category and assigning a food value to each respective portion, in units, wherein the food value is based, at least, on the following parameters; calories, sugar content, fiber content, fat content, and processed content (including additives and processed sugars);
(2) determining a dieter's base food allowance, in terms of the units, based at least on one or more of the following parameters of the dieter:
(a) gender;
(b) age;
(c) height;
(d) weight; and
(e) life activity;
(3) establishing an activity index, which includes a variety of exercises that could be performed by a dieter, defined in terms of a time interval for which the exercise is performed, and assigning a value, in the units, to each time interval;
(4) determining, for the dieter, a daily food allowance, in said units, as the sum of the base food allowance and values obtained from the activity index due to corresponding activities that are listed in the activity index being performed by the dieter, and
(5) allowing the dieter to choose, from said food index, portions of foods for consumption, wherein the sum of the food values of the chosen portions of foods is in a predetermined relationship to the daily food allowance, the dieter's choice being subject to the following: the sum of the food values of the chosen portion of food should not vary from the daily food allowance by more than 10%; at least one food portion is selected from each food category for each meal; and at least three meals are consumed each day.

In step (1), each food category may be divided into sub-categories e.g. vegetables are divided into green vegetables and other vegetables, protein is divided into egg, fish/shellfish, white meat, red meat, dairy and raw nuts, fruit (carbohydrates) is divided into all berries and all other fruit, other carbohydrates are divided into starch and grains; fats are divided into oils and butter. Each subgroup is associated with a respective food value.

The food value index may include a limited list of foods, broadly categorised, that should either be limited or avoided, each food being associated with a respective food value.

A formula may be used to provide a rough estimate of a particular food's food value. This will assist a dieter in establishing food values for foods for which the relevant categories or subcategories are uncertain.

The formula used for providing the rough estimate of the food value of a particular food may comprise the following steps;
a) determining a portion size and an associated calorie value of the portion
b) dividing the calorie value of the food portion by a factor between 2.7 and 3;
c) subtracting the fiber and protein content of the food portion, expressed in grams, from the value calculated in step b); and
d) adding the sugar content, fat content and processed content of the food portion, expressed in grams, to the value calculated in step c).
   The value calculated in step d) is the food value of the particular food.

This approach has been found through extensive trial and experiment to yield a satisfactory outcome.

The dieter's base food allowance, determined in step (2), is preferably linked to the quantity of food a dieter can consume each day, before exercise, to lose between one and two pounds of fat weight per week.

In step (2) each parameter is subdivided into particular ranges. Predetermined values are assigned to each range. These ranges, with associated values, are shown in Table 2. A dieter would select the range, within each parameter, that pertains to him. The values associated with each range are added together to calculate the base food allowance of the particular dieter.

By way of example, referring to Table 2, a female, aged between 21 and 30 with a BMI of between 21 and 28 and with a medium life activity would have a base food allowance of 475.

A dieter's BMI may be established using a conventional calculation, i.e weight (in kg) divided by length (in meters) squared. The relevant formula is as follows; Kg/m²=BMI

A dieter's life activity may be based on the dieter's regular daily activities, excluding exercise, i.e. a person with a sedentary lifestyle (i.e. a desk job) would typically have a low life activity, whereas a person who does physical labour typically has a high life activity.

The activity index established in step (3) and shown in Table 3 is divided into three categories, i.e. strength training, high intensity interval or endurance training, and cardio or aerobic activity.

Strength training is further divided into sub-categories including spot training, general strength training using machine or free weights, and circuit training.

High intensity interval or endurance training may be divided into sub-categories including burst training, stair climbing, endurance (running, cycling, swimming, rowing etc), high intensity work-out classes such as zumba or kick-boxing, high-intensity walking, and high-intensity sports such as soccer, tennis or rugby.

Cardio training may be subdivided into sub-categories including exercising on a cardio machine, steady walking, low-intensity work-out classes such as yoga or Pilates, and low intensity sports, such as golf.

Exercise values are based on the duration of performing a particular exercise in one of the aforementioned sub-categories. The duration is measured in 5 minute time intervals with each subsequent 5 minute interval having a higher value than the previous 5 minute interval. For example, the first 5 minutes of stair climbing would award a dieter with 11 units, whereas the second 5 minutes awards the dieter with 13.4. The average for a 30 minute workout would be 13.2 units per 5 minute interval. These values are rounded in Table 3, simplifying implementation of the method

The exercise values assigned to a time interval of performing an exercise within one of the sub-categories may be according to the values reflected in Table 3.

The dieter's daily food allowance. which is the sum of the dieter's base food allowance (in units) and any units awarded due to activities, listed in the activity index, that have been performed by the dieter, represents the food that a dieter should consume each day in order to lose between one and two pounds of fat per week.

In step (5) a dieter is guided to choose foods, from all four food groups, from the listing in the food index, on a portion basis. In practice the dieter should consume not less than 90%, and not more than 110%, of the daily food allowance. If less than 90% is consumed the dieter has the risk of eating too few calories—this can lead to muscle loss and fatigue and, ultimately, to a slower metabolism. If food consumption (in units) exceeds 110% of the daily food allowance then the loss of fat is reduced and zero weight loss may result.

It is evident from the aforegoing that, at least in one aspect, the method of the invention is not focused on calorie intake but rather on the effect of food on the metabolic rate, the energy needed to digest and burn consumed food, and the projected effect of food consumption on glucose production.

The method of the invention may be implemented directly e.g. by a dieter who follows a chart, tables or the like. In a preferred implementation of the method, however, use is made of a computer link, e.g. the internet, which allows a plurality of dieters to interact individually with a program located at a suitable server.

Each dieter, once authorised, is guided to register an online profile. The dieter is prompted to enter information, in accordance with the predetermined parameters, and, in response thereto, a calculation is done to determine the dieter's base food allowance as per the aforementioned step (2).

The dieter is subsequently prompted to enter information on the dieter's activities, on a daily or other regular basis. Each activity which is logged is influenced by the activity index referred to in the aforementioned step (3). Alternatively or additionally the program, in response to data input by the dieter, may generate an activity program, suited for the dieter, which, inherently, will lead to the allocation of units, and an associated activity index, to the dieter's daily food allowance.

In response to the determined base food allowance and logged activities, for the dieter in question, the program then outputs the daily food allowance for the dieter which is the sum of the base food allowance (in units) and allocated units due to activities performed, where the units are provided by the activity index.

In any weight loss program motivation is a key ingredient to success. Motivational factors are introduced by the program and presented to the dieter in various forms i.e. a message which brings home to the dieter the importance of managing food intake using the method of the invention.

Additionally a results-tracking program is started and updated regularly. This allows the dieter to have a personal assessment, commencing at a starting point, which includes data such as the dieter's starting weight, starting waist measurement, base food allowance and activity index. The daily food allowance may be updated as consumed food and/or activities are logged and notification of the updated daily food allowance is given to the dieter by the program.

Other information of interest, primarily related to motivational aspects, may be included and displayed at appropriate intervals to the dieter. For example data on the dieter's goal weight, metabolic age estimate, stress and emotional eating score, and processed food score may be included.

A primary reason behind the use of the personal assessment program lies in the fact that it provides a ready means for implementation of the method of the invention. This however is done in a way which motivates the dieter to achieve targets and to become aware of the effect that the intakes of different types of food might have on the dieter's body. Ultimately the use of the personal assessment program helps the method of the invention to be implemented in a reasonable and not in a stressful manner, and leads the dieter to a healthy eating style which can readily be maintained.

A primary objective of the method of the invention is to enable a dieter to eat balanced meals of healthy foods without suffering from hunger pangs, food cravings, and isolation from family and friends, particularly at meal times. In the last-mentioned respect it is recognised that social considerations can weigh heavily on the effectiveness of a weight management regime and, taken in isolation, a weight management program which a dieter regards as anti-social can cause the dieter to abandon the program in its entirety.

Essentially the method of the invention is based on a method which enables a dieter to balance energy in against energy expended with a deficit to promote fat loss. This allows the dieter to achieve weight loss with minimal or no muscle loss on a consistent and sustainable basis. The food groupings and portion control allow a dieter to maintain a high energy level. Risks which are associated with diabetes and heart disease and which are linked to intake of certain food types are reduced in the method of the invention.

### BRIEF DESCRIPTION OF THE REPRESENTATIONS

The invention is further described by way of example with reference to the accompanying representations wherein:

Table 1, is a food index, reflecting four categories of food, sub-divided into sub categories, with a portion size assigned to each sub-category and a food value, in units, associated with each respective portion,
Table 2 is a chart reflecting parameters used for determining a base food allowance with a value assigned to each range within each parameter.,
Table 3 reflects an activity index divided into three main categories of exercise,
Table 4 illustrates a food log which allows a record to be kept of the actual daily food consumption of a dieter and a comparison to be made between the actual daily food consumption and the daily food allowance of the dieter; and

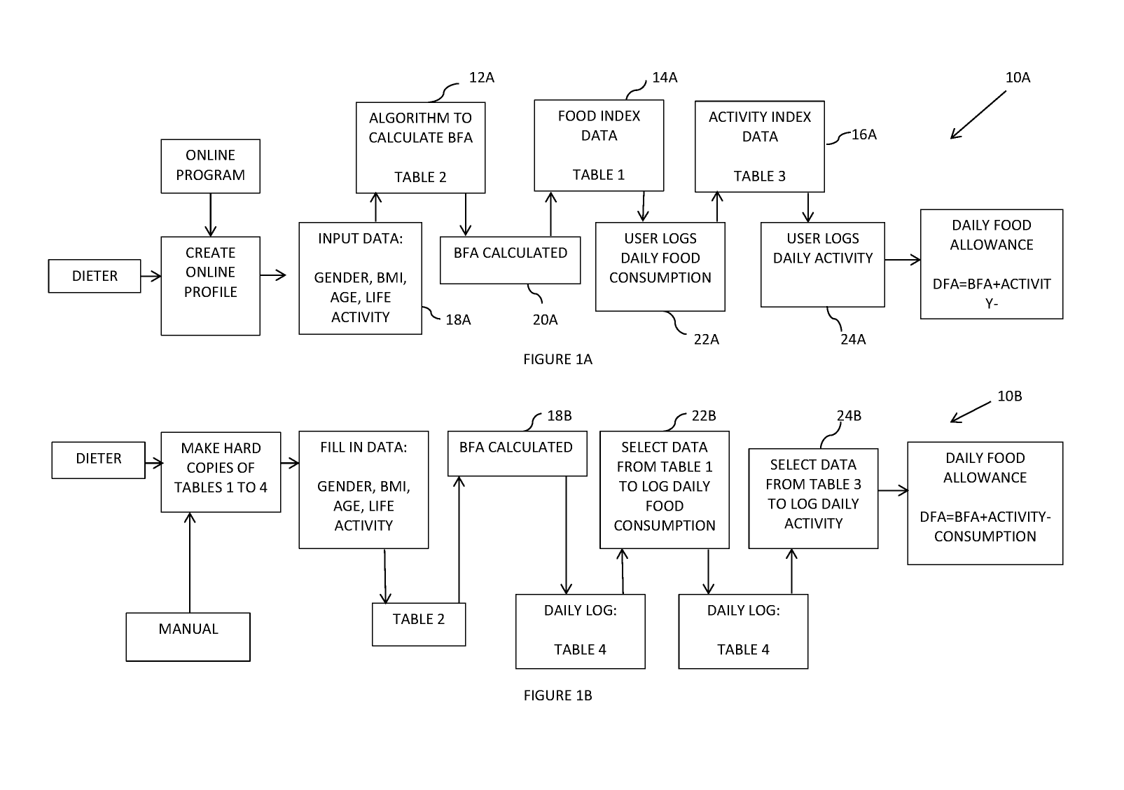

FIG. 1A and FIG. 1B are diagrammatic representations showing, in simplified form, how the method of the invention is implemented.

### DESCRIPTION OF PREFERRED EMBODIMENTS

FIG. 1A is a flowchart 10A depicting various steps in implementing the method of the invention using a computer/internet based program. FIG. 1B is a flowchart 10B depicting various steps in implementing the method of the invention manually.

The method of the invention depends on the creation and use of a unit which is a common measure used to link, in respect of a dieter, food values of defined portions of each of a variety of foods to a base food allowance for the dieter and to activities performed by the dieter.

The creation of the index is a key factor in that, inter alia, its use substantially facilitates understanding of, and putting into practice, the invention, by the dieter.

As an initial step, a food index is established. In this index food varieties are divided into four main categories including vegetables, protein, carbohydrates and fats. Each category is divided into sub-categories as follows; vegetables are divided into green vegetables and other vegetables (red, white, orange); protein is divided into; egg, fish/shellfish, white meat, red meat, dairy and raw nuts, carbohydrates are divided into; berries, other fruit, starch and grains and fats are divided into oils, salad dressing and butter. Each sub category is assigned a value which is referred to as the “food value”, represented in units.

Table 1 is a food index which reflects portion sizes (third column) that are allocated to each sub-category of food, and of food values (fourth column) associated with each portion. The food values of Table 1 are used in the method of the invention according to the following example: a portion (1 cup) of green vegetables has a food value of 10 units; one portion (3 ounces) of white meat has a food value of 40 units and one portion (½ cup) of starch has a food value of 40 units.

The index also includes a list of foods which should either be limited or avoided. These foods are also defined in terms of portions, with a food value assigned to each portion.

An objective is to address shortcomings of the caloric system and to provide dieters with a substantially simplified method for calculating the food energy consumed. By creating broad categories of foods, characterised by respective portions and food values (i.e. units), it becomes possible and practical to avoid assigning food values to literally hundreds of types of foods.

Each food value for the corresponding portion is based on the following; calorie content (energy value), sugar content (glucose and insulin effect), fiber content, protein content, fat content and processed content (additives and refined sugars and health benefit or lack of)

A general formula for determining the food value (FV) for each type of food requires the following:

For a given amount of food, i.e. a portion expressed in a conventional measurement unit (a cup an ounce, a tablespoon, millilitres, grams or the like), the following assessments are made:
1 a base energy value (B) is determined by dividing the calorie value of the food portion by a factor of 2.7 to 3;
2. the following values are established in grams;

| | |
|---|---|
| 2.1 | fiber content (F); |
| 2.2 | protein content (P); |
| 2.3 | sugar content (S); |
| 2.4 | fat content (FT); and |
| 2.5 | processed content (PC). |

The food value for the chosen portion is established by subtracting the positive values items (fiber and protein) from the base energy value and by adding the negative value items (sugar, fat and processed content) to the base energy value, as follows:

B−F−P+S+FT+PC=FV

The formula has been established, by trial and experimentation, as an effective basis for implementing the method of the invention.

While performing the calculation, the values may be rounded for simplicity.

Clearly it is possible to scale the food value up or down, to a convenient-to-use figure, by correspondingly increasing or decreasing the size of the portion.

The method of the invention focuses on whole foods and on feeding the body nutritious foods which are low in preservatives and additives and which are not necessarily low in fat or calories. The intention is to control satiety and to sustain energy while energising the metabolism. The food intake program of the present invention is not intentionally based on a restricted caloric diet.

The method of the invention is also designed to ensure that a dieter consumes balanced meals which include food selected from each food category i.e. protein, fat, carbohydrates, starches and fruit and vegetables to optimise insulin effects and to maximise energy while causing the body to burn fat without any meaningful muscle loss.

The food index, referred to in connection with Table 1, constitutes a fundamental aspect of the method of the invention and is non-variable in that it is not dieter-specific and applies equally to all dieters. The food index provides a clearly ascertainable numerical basis for the invention

The food values of each category are relatively small and portion dependent.

As an example using average values per category, as per Table 1 a dieter can, without difficulty, calculate a lunch meal value of 150 units (food values) assuming 1 portion (1 cup) of green vegetables (10), 2 portions (i.e. 2×3 ounces) of protein (2×40), 1 portion (i.e. 1 medium potato) of carbohydrate (40) and 1 portion (i.e. 1 tsp.) of fat (butter) (20). Once a dieter is familiar with the portions and system a written calculation would not be necessary. A dieter could, however, also be very specific with foods selected to decrease or increase the energy (food) intake for that meal by changing a specific food or by adding another portion or part portion. As an example: a dieter could simply add 1 additional carbohydrate, and ½ a cup of berries, to take the meal energy allowance from 150 to 190 units which might relate to an increase of the daily food allowance due to exercise activity.

Using the formula of the invention, the food value (in units) per food type is generally equated to between 2.7 and 3 calories per unit. As an example: the food value of the meal described above, of 150 units, equates to about 450 calories at a ratio of 3 calories per food value. If duplicated for 3 meals as a daily example this equates to 450 units and approximately 1,350 calories.

In practice the dieter should consume not less than 90%, and not more than 110%, of the daily food allowance. If less than 90% is consumed the dieter has the risk of eating too few calories—this can lead to muscle loss and fatigue and, ultimately, to a slower metabolism. If food consumption (in units) exceeds 110% of the daily food allowance then the loss of fat is reduced and zero weight loss may result.

It is also important that the dieter should consume at least three meals a day, at spaced intervals, to ensure that his metabolism does not slow down during the course of the day.

Table 2 shows a chart which, in respect of a dieter, allows that dieter to perform a metabolic calculation to determine his or her base food allowance in terms of units which correspond to the units used to represent food values, as per Table 1.

The base food allowance is linked to the following parameters, namely: the dieter's gender, age, body mass index (BMI) and life activity, as set out in a first column of Table 2. Other parameters, such as the dieter's height, weight and waist circumference can be used as an alternative to the dieter's BMI. A second column of Table 2 contains, in respect of each of the aforementioned parameters, the number of units in the corresponding base food allowance.

A third column in Table 2 allows a dieter to enter the number of units which apply to that dieter. For example, a male dieter in the age group of 51 to 60, with a BMI score of 36+, and with a medium life activity index, has a base food allowance of 470 units.

The values in Table 2 are used to establish whether a dieter should optimally consume more or less food values (units) per meal or per day. A formula is used to generate a personalized base food allowance value (BFA) which would be the ideal food consumption for a dieter using the food value index before any exercise activity.

It is generally established that males have higher base metabolic rates than females and, as such, gender is the dominant variable in determining the BFA. The value assigned to a dieter based on gender is known as the base allowance.

A dieter's metabolism slows down with age. In Table 2, the scale typically has a 5 point drop by decade. Exceptions are for the decades between 31 to 40, and 41 to 50 where there is a 10 point drop to accommodate the known drop in metabolism from age 35.

The higher a dieter's body mass index (BMI) the less his metabolism performs and the more weight the dieter needs to lose. BMI is calculated by dividing the dieter's weight, in kgs, by his height in meters squared. By way of example, a person that is 1.8 m tall and that weighs 80 kg will have a BMI of about 24.7 (80/[1.8]²). Manually the BMI calculation could be replaced with other body mass composition estimates such as waist circumference.

Life activity relates to a dieter's energy requirements based on life and work activity before exercise activity.

As an example, a 65 year old male with a BMI of 36 and with a sedentary lifestyle has a BFA of 450. A 20 year old male with a BMI under 20 and with high life activity has a BFA of 530

To avoid exercise-induced muscle loss or muscle loss due to an insufficient energy intake, an activity index was created to increase the food allowance of a dieter based on an exercise activity. The increased food allowance also serves to motivate the dieter to be active.

Table 3 shows the activity index, in units which correspond to the units which apply to Table 1 and Table 2. The activity index is determined in accordance with exercise type i.e. strength training, high intensity interval training/endurance training and cardio (constant-medium intensity) and the duration of the exercise. Each exercise type is further subdivided into more specific categories of exercise.

Exercise value points are based on the duration of performing a particular exercise. The duration is measured in 5 minute time intervals with each subsequent 5 minute interval having a higher value than the previous 5 minute interval. The incremental increase in exercise value encourages exercise for longer intervals.

If a dieter performs a particular exercise for a defined time interval, the value determined by the activity index can be added to the BFA, increasing the daily food allowance of the dieter.

Thus, with reference to Table 3, if a dieter does strength training for 20 minutes together with 15 minutes of steady walking the activity index for that dieter per day is 85 units.

In one preferred method of use, an online program enables a dieter to create an online profile which includes all relevant personal information, and his particular weight loss goal. The program uses this information to calculate the dieter's daily food allowance. See FIG. 1A which relates to a software implementation of the invention. FIG. 1B relates to a manual implementation of the invention

The flowchart 10A of FIG. 1A shows the process of implementing the invention using the program, programmed with data 12A relating to the calculation of a dieter's BFA (Table 2), the food index data 14A (Table 1) and activity index data 16A (Table 3) is programmed into the program

In a step 18A, the dieter inputs data, i.e. gender, age, BMI, and life activity to the program. The software includes an algorithm that uses the input data to calculate the BFA (step 20A).

During the course of the day, the dieter may consume food and participate in activities, the information of which is logged to the program (steps 22A and 24A, respectively). The program will use the information to calculate or update the dieter's daily food allowance, in units, based on the information provided by the respective indexes

For each activity the dieter participates in, the type and duration is logged and value, in units based on the activity index data, is added to the dieter's BFA, by the program, and is updated on the dieter's profile.

For each food type that is consumed and logged by the dieter, the unit value based on the food index data is subtracted from the dieter's DFA, by the program and is updated on the dieter's profile.

As food consumption and activities are logged by the dieter and the DFA has correspondingly been updated by the program, a dieter interface associated with the program notifies the dieter whether his DFA has increased or decreased. In the method of the invention the concept of a daily food allowance for a dieter is established as the sum of the dieter's base food allowance and activity index.

As an alternative, the program can provide the dieter with a daily/weekly activity goal which must be achieved in order to lose weight.

The program provides the dieter with a reasonable period within which to achieve his weight loss goal, and keeps track of the dieter's daily food intake in units, as well as the progress made in terms of weight loss, provided the dieter diligently logs his meals and regularly updates physical changes on his profile regularly.

Table 4 provides is a table used to implement the invention manually. Table 4 is a template allowing the dieter to log food values, daily, for consumed meals (breakfast, lunch, dinner and snacks) as well as daily activities, for 7 days.

The process for manual implementation of the invention is described by the flowchart 10B of FIG. 1B. In a step 18B, a. dieter will determine his BFA using the data provided by Table 2. The BFA is tabled in a space 26 provided on Table 4. If the dieter participated in a particular activity for a defined duration (or plans to participate in the activity), the activity index is used to determine the applicable value, in units, that is assigned to the relevant time interval of the particular activity. Once determined, the value is logged, during a step 24B in a space 28 (Table 4) creating the DFA.

In a step 22B, the dieter logs his daily food consumption in the space 30 provided. Food consumption is divided into three meals, i.e. breakfast, lunch and dinner and two daily snacks. Food values are selected from the food index (Table 1), based on the food type and the portion size of the consumed food.

The sequence of the steps in FIGS. 1A and 1B are exemplary only and the steps may be carried out in a different order. For example, the dieter may log exercise activities intended for later in the day in advance to increase his DFA at the start of the day.

There are four food groups, namely protein, vegetable, carbohydrate and fat. The dieter is typically allowed two protein portions and two carbohydrate portions, one vegetable portion and one fat portion for breakfast. For lunch the dieter should have two protein portions, two vegetable portions, one carbohydrate portion and one fat portion. For dinner the dieter should have one portion of protein, two vegetable portions, one carbohydrate portion and one fat portion. Provision may also be made for the consumption of snacks, drinks or supplements. This aspect is of a minor nature though.

Table 4 covers three meals a day namely breakfast, lunch and dinner for seven days a week i.e. from Monday to Sunday. The daily food allowance is applicable to each day. In Table 4 each day heads a column which bridges breakfast, lunch and dinner and, at the end of each day, the dieter can calculate, in the defined units, the quantity of food consumed in that day. That quantity should be compared to the daily food allowance. As stated the actual quantity of food, in units, consumed each day should be not less than 90% of the daily food allowance and not greater than 110% of the daily food allowance.

The food groups used in the method of the invention are vegetables, protein, carbohydrates (which includes starches and fruit) and fat. The method requires the inclusion of at least one portion of each food group in each meal and promotes the consumption of three meals a day using all four food groups, with snacks, as may be appropriate. This scheme assists with the stabilisation of insulin levels in the dieter.

As an example, a single bagel and a glass of orange juice equate to 300 food value units, and represent approximately one and a half times the glucose and insulin loads which would be created by the consumption of two eggs, a slice of toast, a ½ cup of fruit, a cup of vegetables and one teaspoon of real butter (±175 food value units).

A dieter who ate the bagel and juice would have an insulin spike which results in an increase in fat storage but there would be no protein or fat consumption. Energy levels would rapidly decline within about two hours resulting in a reduction in the metabolism rate and this would create a need for food and sugar. The alternative food consumption proposed would allow the dieter to produce less glucose and insulin. Excess glucose would not be stored as fat. In response to the ingestion of the alternative foods (eggs, toast, fruit etc.) the body would accelerate the metabolic rate, and would seek energy reserves from stored food. Satiety and high energy levels would be maintained for three to four hours or until legitimate hunger pangs again arose.

The method of the invention is linked to the creation of healthy meals using a meal planner which facilitates the making of selections from the food index.

Through the application of the method of the invention a dieter is capable of achieving a consistent fat loss of up to two pounds a week until the desired weight is lost. As a dieter's metabolic rate adjusts due to an increased consumption of healthy food the dieter can increase his intake of food value units. In this way the method of the invention helps a dieter to establish a life-sustainable diet and eating regime.

Although Table 1 is concise, the generalised descriptions of the sub-categories, e.g. white meat, starch, oils etc., allow for a considered decision to be taken when foods, which are not specifically listed, must be evaluated as to portion size and units/portion.

The base food allowance can change depending on variations in the parameters. Thus an increase in the life activity level of a dieter results in an automatic increase in the dieter's base food allowance. Similarly, an increase in age causes the base food allowance to reduce, and so on.

### Test Results

33 subjects participated in a weight management program using the aforementioned principles. The effects of the program on each subject were tracked for a period of 29 weeks.

On average the 33 subjects were 74% compliant in respect of food intake and 75% compliant in respect of exercise i.e. activity index. In other words the subjects consumed, in food terms, approximately 600 units per day (this is about 1700 calories per day) before exercise and before taking into account the “bonus” units associated with each person's activity index. Each person, on average, exercised for 90 minutes per week.

Despite a calorie intake which is meaningfully larger than the intake allowed by a calorie-restrictive diet, the subjects reported an average weight loss of 32 lbs. over the 29 week test period i.e. a weight loss of slightly more than 1 lb. per week. The lowest weight loss over the 29 week period of a subject was 11 lbs. and the highest weight loss of a subject was 49 lbs.

There was a significant reduction (6 inches) in average waist measurement and the average reduction in body mass index was 15%.

The subjects ate whole foods, real fats and sugar and minimised the intake of low fat and sugar substitutes. Despite this, the subjects reduced their triglyceride indexes by 28% and blood glucose levels by 9% with all risk factor indicators lowering significantly.

20 of the 33 participants had metabolic syndrome i.e. they were at risk of diabetes and heart disease, at the start of the trial. At the end of the 29 week period only 2 of these participants had metabolic syndrome and, as a group, risk factors in total were reduced by 64%.

75% of the subjects who were on cholesterol-lowering medications were able to eliminate such medications. 67% eliminated their diabetes medications and 50% eliminated blood pressure medications.

TABLE 1

| | Examples of Recommendations | Portion | Food Values |
|---|---|---|---|
| Vegetables | | | |
| Green (Cooked or raw) | Broccoli, spinach, green beans | 1 cup | 10 |
| Other (Red, white, orange) | Cauliflower, carrots | 1 cup | 20 |
| Protein | | | |
| Egg | | 1 | 25 |
| Fish/Shellfish | Salmon, scallops | 3 oz | 35 |
| White meat | Chicken, turkey, pork | 3 oz | 40 |
| Red meat | Beef, lamb | 3 oz | 45 |
| Dairy | Milk, yoghurt, cheese | 4 oz or ½ cup | 45 |
| Raw Nuts | Walnuts, Almonds | 3 oz or ⅓ cup | 50 |
| Carbohydrates | | | |
| All berries | Blueberries, cherries | ½ cup | 40 |
| All other fruit | Apple, banana | 1 med or ½ cup | 50 |
| Starch | Potato, sweet potato | 1 med or ½ cup | 40 |
| Grains | Brown rice, quinoa, multi-grain bread | ½ cup or 1 slice | 45 |
| Fat | | | |
| Oils (Olive, coconut) | | 1 tbsp. | 10 |
| GOLO salad dressing | | 2 tbsp. | 15 |
| Butter | | 1 teaspoon | 20 |
| Limit | | | |
| Natural condiments | Soy sauce, mustard | 1 tbsp. | 25 |
| Sugars | Honey, syrup, sugar, jam | 1 teaspoon | 25 |
| Dark chocolate | | 2 oz | 40 |
| Peanut butter | | 1 tbsp. | 50 |
| Beer | | 8 oz | 75 |
| Wine | | 4 oz | 75 |
| Hard Liquor | | 2 oz | 75 |
| Bacon/sausage | | 2 oz, 1 link | 75 |
| Deli meat | | 2 oz | 75 |
| Avoid | | | |
| Processed condiments | Bottled dressings, marinades, ketchup etc. | 1 tbsp. | 35 |
| Artificial sweeteners | | 1 tsp/1 packet | 50 |
| Processed beverages (diet) | Soda, juice, coffee drinks, etc. | 8 oz | 75 |
| Processed snacks or desserts | Cookies, chips, ice cream, crackers, etc. | 1 serving | 100 |
| White flour products | Breads, pasta | 1 serving | 100 |
| Processed beverages (reg) | Soda, juice, coffee drinks, etc. | 8 oz | 150 |
| All processed, packaged food | Frozen meals, boxed rice, cereal, etc. | 1 serving | 150 |
| Protein bars/shakes | | 1 shake/1 bar | 150 |
| Mixed drinks w/alcohol | | 1 drink | 150 |
| All fast, convenience foods | Burgers, fries, pizza, fried chicken, etc. | Meal | 175 |

TABLE 2

| | | BFA CALCULATION |
|---|---|---|
| Gender | | |
| Male | 390 | |
| Female | 360 | |
| Age | | |
| <20 | 50 | |
| 21-30 | 45 | |
| 31-40 | 40 | |
| 41-50 | 30 | |
| 51-60 | 25 | |
| 61+ | 20 | |
| Body Mass Composition Estimate | | |
| <20 | 40 | |
| 21-28 | 35 | |
| 29-35 | 25 | |
| 36+ | 20 | |
| Life Activity (not exercise) | | |
| Low (sedentary) | 20 | |
| Medium (some gardening-walking etc.) | 35 | |
| High (physical job) | 50 | |
| Basic Food Allowance | | |

TABLE 3

| | 5 | 10 | 15 | 20 | 25 | 30 |
|---|---|---|---|---|---|---|
| | Min- | Min- | Min- | Min- | Min- | Min- |
| | utes | utes | utes | utes | utes | utes |
| Strength Training | | | | | | |
| Spot Training | 13 | 26 | 41 | 55 | 70 | 86 |
| Strength Training (machines- | 15 | 30 | 46 | 63 | 80 | 97 |
| free weights-TRX etc.) | | | | | | |
| Circuit Training (strength | 14 | 29 | 44 | 60 | 77 | 94 |
| training with cardio | | | | | | |
| intervals) | | | | | | |
| High Intensity Interval/ | | | | | | |
| Endurance Training | | | | | | |
| Burst High Intensity Training | 12 | 26 | 39 | 54 | 68 | 83 |
| Stair climbing | 11 | 22 | 34 | 47 | 59 | 72 |
| Endurance (rowing, | 10 | 22 | 34 | 47 | 59 | 72 |
| swimming) | | | | | | |
| High Intensity Workout | 11 | 23 | 35 | 48 | 61 | 75 |
| Classes (Zumba etc.) | | | | | | |
| High Intensity Walking | 11 | 23 | 35 | 48 | 61 | 75 |
| High Intensity Sports (Soccer/ | 10 | 20 | 31 | 42 | 54 | 66 |
| tennis etc.) | | | | | | |
| Cardio (constant-medium | | | | | | |
| intensity) | | | | | | |
| Cardio machine | 7 | 15 | 22 | 30 | 39 | 47 |
| Steady walking | 7 | 15 | 22 | 30 | 39 | 47 |
| Yoga | 7 | 15 | 22 | 30 | 39 | 47 |
| Low Intensity Sports (golf) | 7 | 15 | 22 | 30 | 39 | 47 |

TABLE 4

| | Week: |
|---|---|
| | Date: |
| Base Food Allowance | |
| Bonus Points (Active Index) | |

*Daily Food Allowance
FOOD GROUP AND

| NUMBER OF PORTIONS | | MON | TUES | WED | THURS | FRI | SAT | SUN |
|---|---|---|---|---|---|---|---|---|
| BREAKFAST | Protein (choose 2 portions) | | | | | | | |
| | Vegetable (1 portion) | | | | | | | |
| | Carbohydrate (choose 2 portions) | | | | | | | |
| | Fat (1 portion) | | | | | | | |
| | TOTAL: | | | | | | | |
| | Supplements/Water | | | | | | | |

| LUNCH | Protein (choose 2 portions) |
|---|---|
| | Vegetable (choose 2 portions) |
| | Carbohydrate (1 portion) |
| | Fat (1 portion) |
| | TOTAL: |
| | Supplements/Water |
| DINNER | Protein (1 portion) |
| | Vegetable (choose 2 portions) |
| | Carbohydrate (1 portion) |
| | Fat (1 portion) |
| | TOTAL: |
| | Supplements/Water |

| | |
|---|---|
| SNACKS | (protein OR combine a protein + carb) |
| | TOTAL: |
| Drinks | |
| | TOTAL: |

CONSUMED DAILY TOTALS
Difference(+/−)

1. A weight management method which includes the following steps:
(1) establishing a food index which includes four main categories of food, namely vegetables, proteins, carbohydrates (including starches and fruit), and fat, defining a portion for each category and assigning a food value to each respective portion, in units, wherein the food value is based, at least, on the following parameters; calories, sugar content, fiber content, fat content, and processed content (including additives and processed sugars);
(2) determining a dieter's base food allowance, in terms of the units, based at least on one or more of the following parameters of the dieter:
(a) gender;
(b) age;
(c) height;
(d) weight; and
(e) life activity;
(3) establishing an activity index, which includes a variety of exercises that could be performed by the dieter, defined in terms of a time interval for which the exercise is performed, and assigning a value, in the units, to each time interval;
(4) determining, for the dieter, a daily food allowance, in said units, as the sum of the base food allowance and values obtained from the activity index due to corresponding activities that are listed in the activity index being performed by the dieter, and
(5) allowing the dieter to choose, from said food index, portions of foods for consumption, wherein the sum of the food values of the chosen portions of foods is in a predetermined relationship to the daily food allowance.

2. A method according to claim 1 wherein the dieter's choice of food is subject to the following: the sum of the food values of the chosen portion of food should not vary from the daily food allowance by more than 10%; at least one food portion is selected from each food category for each meal; and at least three meals are consumed each day.

3. A method according to claim 1 wherein, in step (1), each food category is as follows;
3.1 vegetables are divided into green vegetables and other vegetables;
3.2 protein is divided into egg, fish/shellfish, white meat, red meat, dairy and raw nuts;
3.3 fruit (carbohydrates) is divided into all berries and all other fruit and other carbohydrates are divided into starch and grains;
3.4 fats are divided into oils and butter; and
wherein each a respective food value is associated with each subgroup

4. A method according to claim 1 wherein the food value index includes a list of foods that should be limited or avoided, each food being associated with a respective food value.

5. A method according to claim 1 wherein a formula is used to provide an estimate for establishing the food values of foods for which the relevant categories or subcategories are uncertain.

6. A method according to claim 1 wherein the formula for determining the food value of a particular food comprises the following steps;
a) determining a portion size and an associated calorie value of the portion
b) dividing the calorie value of the food portion by a factor between 2.7 and 3;
c) subtracting the fiber and protein content of the food portion, expressed in grams, from the value calculated in step b); and
d) adding the sugar content, fat content and processed content of the food portion, expressed in grams, to the value calculated in step c).

7. A method according to claim 1 wherein the dieter's base food allowance, determined in step (2), is preferably linked to the quantity of food a dieter can consume each day, before exercise, to lose between one and two pounds of fat weight per week.

8. A method according to claim 1 wherein, in step (2), each parameter is subdivided into particular ranges with predetermined values assigned to each range and, to determine the base food allowance, a dieter would select the range, within each parameter, that pertains to him and add the values.

9. A method according to claim 1 wherein the dieter's BMI is established using a conventional calculation of weight (in kg) divided by length (in meters) squared.

10. A method according to claim 1 wherein a dieter's life activity is based on the dieter's regular daily activities, excluding exercise.

11. A method according to claim 1 wherein the activity index established in step (3) comprises three categories, i.e. strength training, high intensity interval or endurance training, and cardio or aerobic activity.

12. A method according to claim 11 wherein strength training is further divided into sub-categories including spot training, general strength training and circuit training.

13. A method according to claim 11 wherein high intensity interval or endurance training is divided into sub categories including burst training, stair climbing, endurance (running, cycling, swimming, rowing etc), high intensity work-out classes such as zumba or kick-boxing, high-intensity walking and high-intensity sports such as soccer, tennis or rugby.

14. A method according to claim 11 wherein cardio training is subdivided into sub-categories including exercising on a cardio machine, steady walking, low-intensity work-out classes and low intensity sports.

15. A method according to claim 11 wherein the exercise values are based on the duration of performing a particular exercise in one the sub-categories.

16. A method according to claim 11 wherein the duration is measured in 5 minute time intervals with each subsequent 5 minute interval having a higher value than the previous 5 minute interval.

17. A method according to claim 11 wherein the exercise values assigned to a time interval of performing an exercise within one of the sub-categories is according to the values reflected in Table 3.

18. A method according to claim 1 wherein the dieter's daily food allowance, is the sum of the dieter's base food allowance (in units) and any units awarded due to activities, listed in the activity index, that have been performed by the dieter and represents the food that the dieter should consume each day in order to lose between one and two pounds of fat per week.

19. A method according to claim 1 which is implemented directly by a dieter who follows a chart, tables or the like.

20. A method according to claim 1 which is implemented by making use of a computer link to the internet, allowing a plurality of dieters to interact individually with a program located at a suitable server.

21. A method according to claim 20 wherein each dieter, once authorized, is guided to register an online profile and is prompted to enter information, in accordance with the predetermined parameters, and, in response thereto, a calculation is done to determine the dieter's base food allowance as per step (2).

22. A method according to claim 20 wherein the dieter is subsequently prompted to enter information relating to the dieter's activities, on a daily or other regular basis and each activity which is logged is influenced by the activity index referred to in step (3).

23. A method according to claim 20 wherein the program, in response to data input by the dieter, generates an activity program, suited for the dieter, which, inherently, will lead to the allocation of units, associated with the activity index, to the dieter's daily food allowance.

24. A method according to according to claim 20 wherein, in response to the determined base food allowance and logged activities for the dieter in question, the program outputs the daily food allowance for the dieter.

25. A method according to claim 20 wherein motivational factors are introduced by the program and presented to the dieter in various forms such a message which brings home to the dieter the importance of managing food intake using the method of the invention.

26. A method according to claim 20 wherein a results-tracking program is started and updated regularly, allowing the dieter to have a personal assessment, commencing at a starting point, which includes data such as the dieter's starting weight, starting waist measurement, base food allowance and activity index.

27. A method according to 20 wherein the daily food allowance is updated as consumed food and/or activities are logged and notification of the updated daily food allowance is given to the dieter by the program.

28. A method according to claim 20 wherein other information of interest, primarily related to motivational aspects, is included and displayed at appropriate intervals to the dieter, the information including data on the dieter's goal weight, metabolic age estimate, stress and emotional eating score, and processed food score.
